(19) United States
(12) Patent Application Publication
(10) Pub. No.: US 2023/0164544 A1
(43) Pub. Date: May 25, 2023

(54) METHOD AND SYSTEM TO PERFORM RACS OPERATION

(71) Applicant: Samsung Electronics Co., Ltd., Suwon-si, Gyeonggi-do (KR)

(72) Inventors: Lalith KUMAR, Bangalore (IN); Varini GUPTA, Bangalore (IN); Kundan TIWARI, Bangalore (IN); Anikethan Ramakrishna Vijaya KUMAR, Bangalore (IN)

(21) Appl. No.: 17/917,825

(22) PCT Filed: Apr. 7, 2021
(86) PCT No.: PCT/KR2021/004376

§ 371 Date: Oct. 7, 2022

(30) Foreign Application Priority Data
Apr. 7, 2020 (IN) 202041015299
Apr. 5, 2021 (IN) 2020 41015299

(51) Int. Cl. H04W 8/22; H04W 36/00

(52) U.S. Cl. CPC H04W 8/22; H04W 36/0061

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). Embodiments herein provide a method of User Equipment (UE) handover from a Source-Radio Access Network (S-RAN) to a Target-Radio Access Network (T-RAN). The method comprises detecting whether the S-RAN and the T-RAN both support UE (101) Radio Capability (URC) signaling optimization. Further, determining whether a URC information corresponding to a URC Identification (URC-ID) is available at the T-RAN. Furthermore, sending the URC information to the T-RAN upon determining un-availability of the URC information at the T-RAN, or sending the URC-ID to the T-RAN upon determining availability of the URC information at the T-RAN. Finally, performing handover procedure with the UE (101) using one of the URC-ID and the URC information.

### TECHNICAL FIELD

The present invention relates to field of wireless communication technology and in particular relates to a method and system to perform Resource and Admission Control Subsystem (RACS) operation.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In recent times, with change in the wireless communication technology there is an increase in the size of User Equipment (UE) Radio Capability (URC) information shared by the UE with a base station i.e. Radio Access Network (RAN). The URC information comprises, for example, one or more frequency bands supported by the UE, a power class supported by the UE, and the like. The URC information is used by the RAN for providing one or more services to the UE. An efficient approach to signal URC information over the radio interface and other network interfaces to the RAN is defined using a URC optimization technique i.e. RACS. The RACS works by assigning an identifier to represent a set of UE radio capabilities. This identifier is called UE Radio Access Capability Identification (URC-ID). The URC-ID of the UE may be assigned by at least one of a UE manufacturer or a Public Land Mobile Network (PLMN). The URC-ID is an alternative to the signaling of the UE radio capabilities over the radio interface, within New Generation (NG) RAN, from NG-RAN to E-UTRAN, from Access and Mobility Management Function (AMF) to NG-RAN, and between CN nodes supporting RACS.

A UE Radio Capability Management Function (UCMF) in a core network stores a mapping between the URC-ID of the UE and the corresponding URC information in the PLMN. Further, the UCMF assigns the URC-ID to the UE within the PLMN. The URC-ID stored in the UCMF may be associated to one or more formats used to store the URC information. The one or more formats includes TS 36.331 (this is also called as EPS format) and TS 38.331 (this is also called as 5GS format). The URC-ID is signaled in the core network with an indication denoting the format of the URC information corresponding to the URC-ID. The one or more formats of the URC information is identifiable by the AMF and the UCMF. Further, the AMF stores the TS 38.331 format only.

The NG-RAN in a PLMN may be configured in two modes of operation. In the first mode of operation (i.e. Mode-A) the NG-RAN provides the URC information to the AMF in both formats (i.e. the TS 38.331 format and the corresponding TS 36.331 format). The NG-RAN generates the URC information in TS 36.331 format by transcoding the TS 38.331 format received from the UE using a URC Enquiry procedure [see TS 38.331). In the second mode of operation (i.e. Mode-B) the NG-RAN provides the URC information to the AMF in the TS 38.331 format only.

When the PLMN supports only 5GS, the second mode of operation (i.e. Mode-B) is configured in the NG-RAN. When the PLMN supports RACS in both EPS and 5GS and if the RAN nodes in the EPS and 5GS are configured in the second mode of operation (i.e. Mode-B), then the UCMF transcodes the URC information from the TS 36.331 format to TS 38.331 format and vice versa. When the PLMN supports RACS in both EPS and 5GS and if the NG-RAN is configured to operate in the first mode of operation (i.e. Mode-A), then the E-UTRAN is configured to operate in the first mode of operation (i.e. Mode-A) and the UMCF is not required to transcode between TS 36.331 and TS 38.331 formats.

When the NG-RAN updates the new URC information to the AMF, the AMF checks whether the URC-ID corresponding to the URC information of the UE is available in the mapping. If the URC-ID is available, then the AMF provides the URC information obtained from the NG-RAN to the UCMF, along with the existing URC-ID of the UE. Further, the UCMF provides a value of URC-ID to the AMF. The value of the URC-ID provided by the UCMF may be one of same as the existing value of the URC-ID, or a new value of the URC-ID for the UE. When the new value of URC-ID is provided by the UCMF, the AMF updates the existing URC-ID with the new value of the URC-ID for the UE. Further, the AMF provides the new value of the URC-ID of the UE to the NG-RAN and to the UE. Now mainly considering from the Handover perspective there are potential services which cannot tolerate any kind of delay for example Ultra-reliable Low Latency Communication (URLLC) services. If during the handover procedure source RAN node provides URC ID to the target RAN node and target RAN node does not have the URC ID then target RAN node needs to resolve it from the core network and receive the mapped URC information. If core-network also fails to resolve the URC ID and is not able to provide URC information, the target RAN node is forced to resolve the URC information from the UE at the radio interface. All this additional procedures are required to be executed even though source RAN node was already having the URC information and instead source RAN node provides URC ID to the target RAN node to save resources at the interface between source RAN node and target RAN node by reducing the size of information sent i.e. instead of huge URC information only URC ID is sent. This additional procedures leads to a delay during a handover of the UE from one RAN to other RAN. Further, the delay may lead to loss of communication at the UE.

Thus, it is desired to address the above mentioned disadvantages or other shortcomings or at least provide a useful alternative.

### DISCLOSURE OF INVENTION

### Technical Problem

The principal object of the embodiments herein is to provide a method and system to perform RACS operation.

Another object of the embodiments herein is to reduce the delay during the handover of the UE.

Another object of the embodiments herein is to avoid the resolution or generation of the URC-ID due to different formats used to represent the URC information.

### Solution to Problem

Accordingly the embodiments herein provide a method of User Equipment (UE) handover from a Source-Radio Access Network (S-RAN) to a Target-Radio Access Network (T-RAN). The method comprises detecting, by the S-RAN, whether the S-RAN and the T-RAN both support UE Radio Capability (URC) signaling optimization. Upon detecting the support for the URC signaling optimization, the method comprises determining, by the S-RAN, whether a URC information corresponding to a URC Identification (URC-ID) is available at the T-RAN. Further, the method comprises sending, by the S-RAN, the URC information to the T-RAN upon determining unavailability of the URC information corresponding to the URC-ID at the T-RAN. Alternatively, the method comprises sending, by the S-RAN, the URC-ID to the T-RAN upon determining availability of the URC information corresponding to URC-ID at the T-RAN. Finally, the method comprises performing, by the T-RAN, a handover procedure with the UE using one of the URC-ID and the URC information.

In an embodiment, determining, by the S-RAN, whether the URC information corresponding to the URC-ID is available at the T-RAN comprises identifying a format of the URC information corresponding to the URC-ID stored in the S-RAN. Further, identifying the format of the URC information supported by the T-RAN. Furthermore, determining the availability of the URC information corresponding to URC-ID at the T-RAN when the format of the URC information corresponding to the URC-ID stored in the S-RAN is same as the format of the URC information supported by the T-RAN.

In an embodiment, determining, by the S-RAN, whether the URC information corresponding to the URC-ID is available at the T-RAN comprises determining whether the URC information stored in the S-RAN is obtained from an Access and Mobility Management Function (AMF). Further, determining the un-availability of the URC information at the T-RAN when the URC information stored in the S-RAN is obtained from the AMF.

In an embodiment, performing, by the T-RAN, the handover procedure comprises receiving the URC information from the S-RAN; and completing the handover procedure using the URC information.

In an embodiment, performing, by the T-RAN, the handover procedure comprises receiving the URC information from the S-RAN; receiving the URC-ID from the AMF; and completing the handover procedure using the URC information received from the S-RAN.

Accordingly the embodiments herein provide a Source-Radio Access Network (S-RAN) for performing a User Equipment (UE) handover to a Target-Radio Access Network (T-RAN), wherein the S-RAN comprises a memory, a processor; and a UE Radio Capability (URC) controller communicatively coupled with the processor and the memory. The URC controller is configured to detect whether the S-RAN and the T-RAN both support UE Radio Capability (URC) signaling optimization. Further, the URC controller is configured to determine whether a URC information corresponding to a URC Identification (URC-ID) is available at the T-RAN, upon detecting the support for the URC signaling optimization. Furthermore, the URC controller is configured to send the URC information to the T-RAN upon determining unavailability of the URC information corresponding to the URC-ID at the T-RAN. Alternatively, the URC controller is configured to send the URC-ID to the T-RAN upon determining availability of the URC information corresponding to URC-ID at the T-RAN. Further, the T-RAN performs a handover procedure with the UE using one of the URC-ID and the URC information.

In an embodiment, the URC controller is configured to determine whether the URC information corresponding to the URC-ID is available at the T-RAN comprises identifying a format of the URC information corresponding to the URC-ID stored in the S-RAN. Further, identifying the format of the URC information supported by the T-RAN. Furthermore, determining the availability of the URC information corresponding to URC-ID at the T-RAN when the format of the URC information corresponding to the URC-ID stored in the S-RAN is same as the format of the URC information supported by the T-RAN.

In an embodiment, the URC controller is configured to determine whether the URC information corresponding to the URC-ID is available at the T-RAN comprises determining whether the URC information stored in the S-RAN is obtained from an Access and Mobility Management Function (AMF). Further, determining the unavailability of the URC information at the T-RAN when the URC information stored in the S-RAN is obtained from the AMF.

Accordingly the embodiments herein provide a Target-Radio Access Network (T-RAN) for performing a User Equipment (UE) handover from a Source-Radio Access Network (S-RAN), wherein the T-RAN comprises a memory, a processor, and a UE Radio Capability (URC) controller communicatively coupled with the processor and the memory. The URC controller is configured to receive a URC information from the S-RAN, wherein the S-RAN sends the URC information upon determining availability of the URC information corresponding to the URC-ID at the T-RAN. Further, the URC controller is configured to receive the URC-ID from the S-RAN, wherein the S-RAN sends the URC-ID upon determining un-availability of the URC information corresponding to URC-ID at the T-RAN. Furthermore, the URC controller is configured to perform a handover procedure with the UE using one of the URC-ID and the URC information.

In an embodiment, the URC controller is configured to perform the handover procedure comprises receiving the URC information from the S-RAN. Further completing the handover procedure using the URC information.

In an embodiment, the URC controller is configured to perform the handover procedure comprises receiving the URC information from the S-RAN. Further, receiving the URC-ID from the AMF. Furthermore, completing the handover procedure using the URC information received from the S-RAN.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to the embodiments of the disclosure, methods to perform RACS operation are provided. Accordingly, the delay during the handover of the UE can be reduced.

### BRIEF DESCRIPTION OF DRAWINGS

The method is illustrated with the accompanying drawings, throughout which like reference letters indicate corresponding parts in the various figures. The embodiments herein will be better understood from the following description with reference to the drawings, in which:

FIG. 1 shows a signaling diagram illustrating problems in the existing methods, according to the prior art;

FIG. 2 shows an exemplary environment for performing User Equipment (UE) handover from a Source-Radio Access Network (S-RAN) to a Target-Radio Access Network (T-RAN), according to the embodiments as disclosed herein;

FIG. 3A shows a simplified block diagram of a User Equipment (UE) according to the embodiments as disclosed herein;

FIG. 3B shows a simplified block diagram of a Radio Access Network (RAN), according to the embodiments as disclosed herein;

FIG. 4 illustrates a flowchart for a method of User Equipment (UE) handover from a Source-Radio Access Network (S-RAN) to a Target-Radio Access Network (T-RAN), according to the embodiments as disclosed herein;

FIG. 5 shows a signaling diagram illustrating a procedure of UE handover when the URC information or the URC-ID is not available in the required format, according to the embodiments as disclosed herein;

FIG. 6 shows a signaling diagram illustrating a procedure of UE registration with a RAN not support the RACS, according to the embodiments as disclosed herein;

FIG. 7 shows a signaling diagram illustrating a procedure of UE (101) handover when the T-RAN supports RACS, according to the embodiments as disclosed herein;

FIG. 8 illustrates a UE, according to embodiments as disclosed herein; and

FIG. 9 illustrates a RAN, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

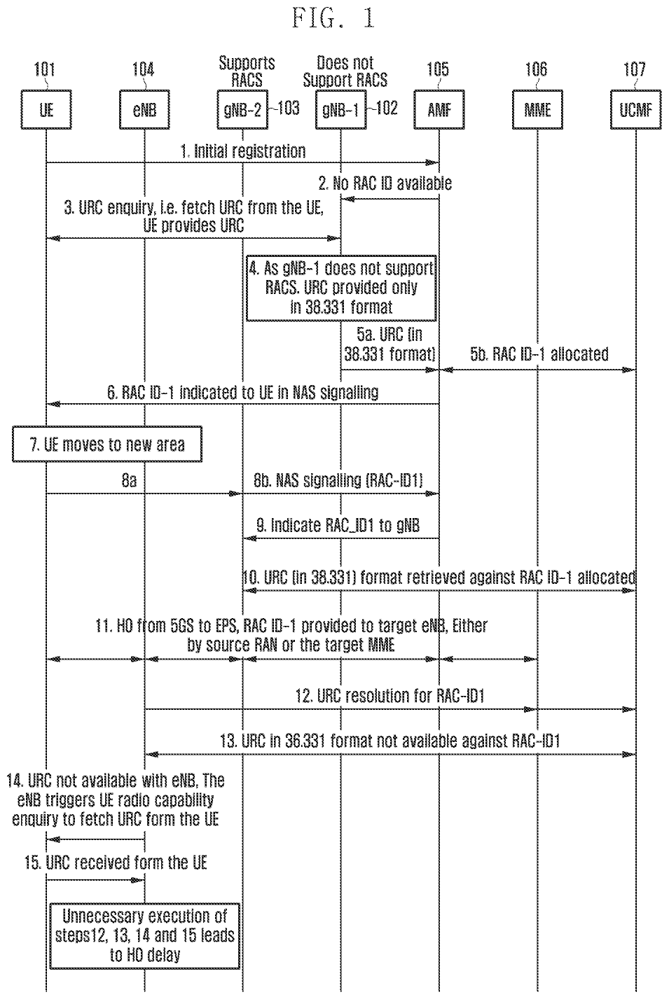

Referring now to the drawings, and more particularly to FIGS. 1 through 6, where similar reference characters denote corresponding features consistently throughout the figures, there are shown preferred embodiments.

FIG. 1 shows a signaling diagram illustrating problems in the existing methods, according to the prior art.

Referring to the FIG. 1, a User Equipment (UE (101)) initiates an initial registration procedure in a 5G system (5GS), when the UE (101) does not have a Radio Access Capability Identification (URC-ID) allocated by the 5GS as indicated by the signal 1 in FIG. 1, sent by the UE (101) to a Access and Mobility Management Function (AMF (105)). The AMF (105) cannot provide UE (101) radio capabilities (URC) information to gNB-1 (102) servicing the UE (101) because the URC-ID is not allocated to the UE (101) and the AMF (105) do not possess the URC information corresponding to the UE (101) in a mapping stored by the AMF (105). The AMF (105) indicates the non-availability of the URC information and the URC-ID corresponding to the UE (101) to the gNB-1 (102) as indicated by the signal 2 in FIG. 1. Further, due to un-availability of the URC information at gNB-1 (102), the gNB-1 (102) fetches the URC information from the UE (101) as indicated by the signal 3 in FIG. 1. The UE (101) provides the URC information in TS 38.331 format, because the gNB-1 (102) does not support URC optimization technique i.e. RACS as indicated by the signal 4 in FIG. 1. Further, the gNB-1 (102) provides the URC information in the TS 38.331 format to the AMF (105) as indicated by the signal 5a in FIG. 1. The gNB-1 (102) will not be able to provide the URC information in both the 38.331 format and the 36.331 format to the AMF (105) because the PLMN is operating in a Mode-A. In Mode-A of operation, the UCMF (107) is not capable of translating or transcoding the URC information from the 38.331 format to the 36.331 format. Alternatively, if the gNB-1 (102) is not upgraded, the gNB-1 (102) is not be able to provide the URC information in both the 36.331 format and the 38.331 format to AMF (105) in the Core Network (CN). The AMF (105) requests URC-ID assignment corresponding to the URC information to the UCMF (107). The UCMF (107) allocates a value of the URC-ID (for example, say URC-ID1) corresponding to the URC information of the UE (101). Further, the URC-ID1 is indicated to the AMF (105) as indicated by the signal 5b in FIG. 1. The AMF (105) provides the URC-ID1 to the UE (101) in a NAS signaling message as indicated by the signal 6 in FIG. 1.

In an embodiment, the UE (101) may move from a geographical area serviced by the gNB-1 (102) to a geographical area serviced by gNB-2 (103) in the 5GS as indicated by the signal 7 in FIG. 1. For example, consider the gNB-2 (103) to support RACS. The UE (101) provides the URC-ID1 in the NAS signaling to the AMF (105)-1 as indicated by signal 8a. and 8b in FIG. 1. The AMF (105) in the CN provides the URC-ID1 of the UE (101) to the gNB-2 (103) because the gNB-2 (103) supports the RACS as indicated by the signal 9 in FIG. 1.

Further, the gNB-2 (103) requests for the resolution of the URC-ID1 from the UCMF (107) in the CN as indicated by the signal 10 in FIG. 1. The gNB-2 (103) receives the URC information in 38.331 format from the UCMF (107) in the CN. The AMF (105) and the UCMF (107) together resolve the URC-ID1 and retrieve the URC information in the 38.331 format from the mapping of the URC-ID and the URC information stored for UEs. The gNB-2 (103) provides communication services to the UE (101) using the URC information obtained from the CN.

In an embodiment, if a handover request is triggered from 5GS to Evolved Packet switched System (EPS), then a target eNB (104) will receive the URC-ID1 of the UE (101) from one of a source gNB (i.e. gNB-2 (103)) or a target MME (106) as indicated by the signal 11 in FIG. 1. The eNB (104) will request the CN including the MME (106) and the UMCF to resolve the URC-ID to the URC information in 36.331 format as indicated by the signal 12 in FIG. 1. The CN indicates to the target eNB (104) un-availability of the URC information corresponding to the URC-ID1 in 36.331 format as indicated by the signal 13 in FIG. 1. In one embodiment, the eNB (104) requests the URC information in 36.331 format from the UE (101) as indicated by the signal 14 in FIG. 1, because the URC information in not available with the eNB (104) and the resolution of the URC-ID is not possible because the URC information in 36.331 format is not available with the UCMF (107). Further, the UE (101) sends the URC information in 36.331 format to the eNB (104) as indicated by the signal 15 in FIG. 1.

Because of the signals as indicated in the steps 12, 13, 14, and 15 there is a delay in the handover procedure of the UE (101) which is not acceptable for time sensitive services such as Ultra-reliable low latency communication. In particular, the steps 14 and 15 including the transmission of the URC information leads to a delay in the handover of the UE (101), because of a size of the URC information.

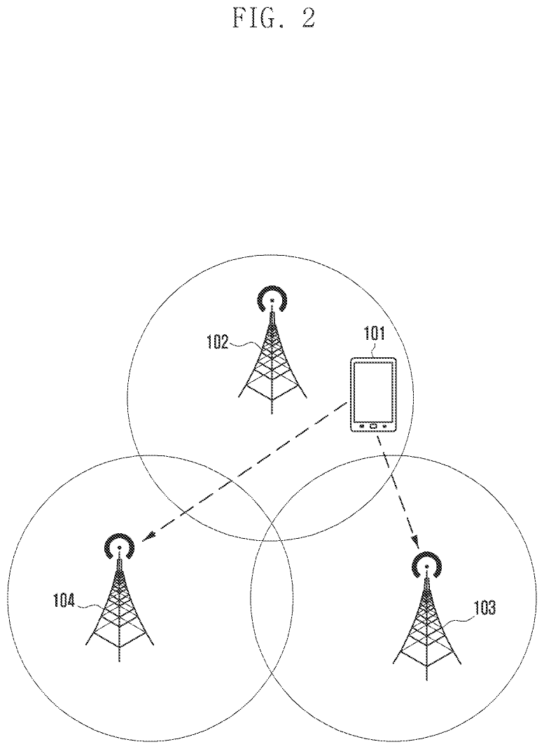

FIG. 2 shows an exemplary environment for performing User Equipment (UE) handover from a Source-Radio Access Network (S-RAN) to a Target-Radio Access Network (T-RAN), according to the embodiments as disclosed herein.

In embodiment, consider the UE (101) initiating an initial registration request with a RAN (i.e. gNB-1 (102)), where the gNB-1 (102) does not support RACS. In the present disclosure the term “RAN” is used to denote “gNB-1 (102)”, “gNB-2 (103)” and “eNB (104)” i.e. it can be node of EPS or 5GS or NG-RAN or any other radio access technology. Further, UE (101) may move from the geographical area serviced by the gNB-1 (102) to the geographical area serviced by the gNB-2 (103), where the gNB-2 (103) supports the RACS. Furthermore, the UE (101) may move from the geographical area serviced by the gNB-2 (103) to the geographical area serviced by the eNB (104). When the UE (101) moves from the geographical area serviced by the gNB-1 (102) to the geographical area serviced by the gNB-2 (103) or eNB (104), the delay in the handover of the UE (101) because of the different formats of the URC information used by the RAN including the g-NB and the eNB (104) is reduced by determining one of the availability or the un-availability of the URC-ID with a target RAN (i.e. gNB-2 (103) and/or eNB (104)).

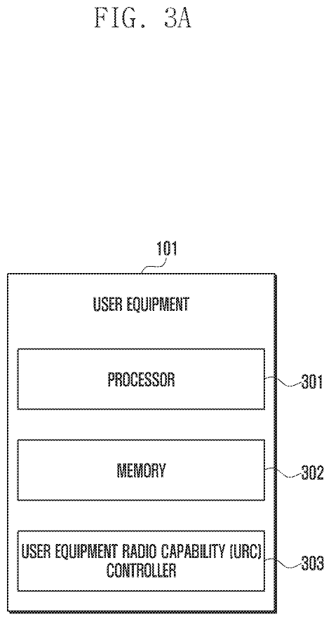

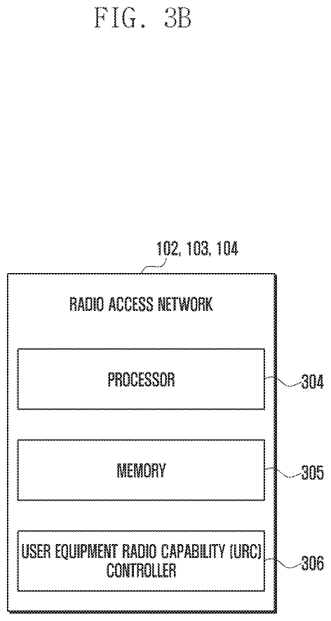

FIG. 3A shows a simplified block diagram of the User Equipment (UE), according to the embodiments as disclosed herein.

In an embodiment, the UE (101) comprises a processor (301), a memory (302) and a URC controller (303). The URC controller (303) is communicatively coupled to the processor (301) and the memory (302). The memory (302) may store the URC information in at least one of 36.331 format and the 38.331 format, the URC-ID obtained from the CN in the PLMN, and the like. Further, the URC controller (303) and the processor (301) is configured to send and receive one or more messages with the RAN and the CN. In particular, the URC controller (303) and the processor (301) is configured to provide the URC information to the RAN, provide the URC-ID to the RAN, and the like.

FIG. 3B shows a simplified block diagram of the Radio Access Network (RAN), according to the embodiments as disclosed herein.

In an embodiment, the RAN comprises a processor (304), a memory (305) and a URC controller (306). The URC controller (306) is communicatively coupled to the processor (304) and the memory (305). The term “RAN” is used to denote “gNB-1 (102)”, “gNB-2 (103)”, and the “eNB (104)”. The memory (305) may store the URC information in at least one of 36.331 format and the 38.331 format corresponding to the UEs serviced by the RAN, the URC-ID obtained from the UE (101) and/or the CN in the PLMN, and the like. Further, the URC controller (306) and the processor (304) is configured to send and receive one or more messages with the UE (101) and the CN.

In particular, the URC controller (306) and the processor (304) is configured to detect whether the S-RAN and the T-RAN both support UE (101) Radio Capability (URC) signaling optimization. Further, the URC controller (306) and the processor (304) is configured to determine whether a URC information corresponding to a URC Identification (URC-ID) is available at the T-RAN. Furthermore, the URC controller (306) and the processor (304) is configured to send at least one of the URC information and the URC-ID to the T-RAN. Thereafter, the URC controller (306) and the processor (304) is configured to perform the handover of the UE (101) from the S-RAN to the T-RAN.

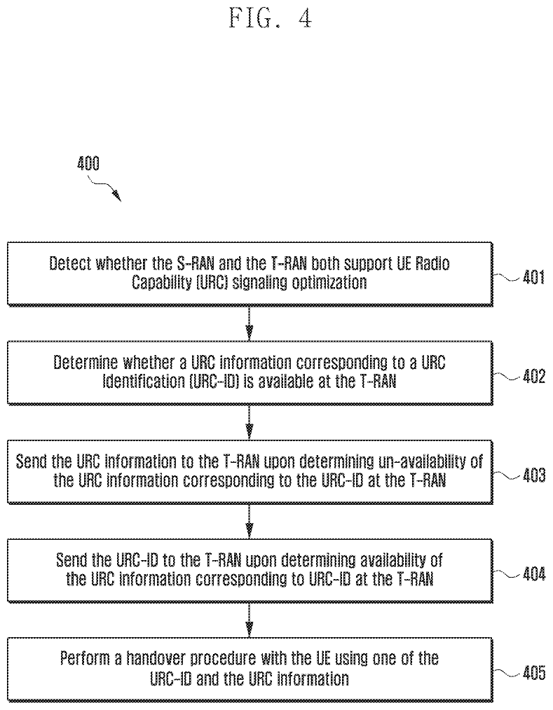

FIG. 4 illustrates a flowchart for a method of User Equipment (UE) handover from a Source-Radio Access Network (S-RAN) to a Target-Radio Access Network (T-RAN), according to the embodiments as disclosed herein.

At the step 401, the S-RAN detects whether the S-RAN and the T-RAN both support UE (101) Radio Capability (URC) signaling optimization.

In an embodiment, the S-RAN denotes the RAN currently providing communication services to the UE (101). The UE (101) currently associated with S-RAN may move or roam to the geographical area (i.e. Cell) serviced by other RAN. The UE (101) moving from one cell to another cell needs to perform the handover procedure from the S-RAN to the T-RAN for continuing to obtain the communication services. The T-RAN denotes the RAN providing communication services in the geographical area adjacent to the geographical area serviced by the S-RAN.

In an embodiment, before and/or during the handover procedure, the URC information of the UE (101) is required to be provided to the T-RAN for providing the communication services to the UE (101). The URC information may be provided to the T-RAN in the at least one of 36.331 format and the 38.331 format. Alternatively, the URC-ID may be provided to the T-RAN. The T-RAN may obtain the URC information corresponding to the URC-ID from the CN.

In an embodiment, to determine whether the URC information is to be provided or the URC information is to be provided to the T-RAN, the S-RAN detects whether the S-RAN and the T-RAN both support UE (101) Radio Capability (URC) signaling optimization. For example, when the S-RAN is the gNB in 5GS and the T-RAN is eNB (104), or vice versa, then the S-RAN detects that T-RAN does not support URC signaling optimization.

At the step 402, upon detecting the support for the URC signaling optimization, the S-RAN determines whether the URC information corresponding to the URC Identification (URC-ID) is available at the T-RAN.

In an embodiment, for determining whether the URC information corresponding to the URC-ID is available at the T-RAN, the S-RAN identifies the format of the URC information corresponding to the URC-ID of the UE (101) stored in the S-RAN. The format of the URC information may be at least one of 36.331 format and the 38.331 format. Further, the S-RAN identifies the format of the URC information supported by the T-RAN. For example, if the T-RAN is the eNB (104), then the S-RAN determines the format of the URC information supported by the T-RAN is the 36.331 format. In one embodiment, the S-RAN may query the T-RAN to determine the format of the URC information supported by the T-RAN.

In an embodiment, the S-RAN determines the availability of the URC information corresponding to URC-ID at the T-RAN when the format of the URC information corresponding to the URC-ID of the UE (101) stored in the S-RAN is same as the format of the URC information supported by the T-RAN. For example, when both the S-RAN and T-RAN use the 38.331 format to store the URC information, then the S-RAN determines that the URC information corresponding to the URC-ID of the UE (101) is available at the T-RAN. In another example, if the S-RAN has stored the URC information in the 38.331 format and the T-RAN supports the 36.331 format, then the S-RAN determines that the URC information corresponding to the URC-ID of the UE (101) is not available at the T-RAN.

In a second embodiment, the S-RAN may determine whether the URC information corresponding to the URC-ID is available at the T-RAN by determining whether the URC information stored in the S-RAN is obtained from an Access and Mobility Management Function (AMF (105)). For example, if the UE (101) performed initial registration with the AMF (105), then the S-RAN obtains the URC information from the AMF (105). Further, the S-RAN determines the un-availability of the URC information at the T-RAN when the URC information stored in the S-RAN is obtained from the AMF (105).

At the step 403, the S-RAN sends the URC information to the T-RAN upon determining the un-availability of the URC information corresponding to the URC-ID at the T-RAN. In a first example, when the S-RAN and the T-RAN both use different formats to store the URC information, then the S-RAN sends the URC information in the format supported by the T-RAN to the T-RAN. In a second example, when the S-RAN has obtained the URC information from the AMF (105), then the S-RAN sends the URC information in the format supported by the T-RAN to the T-RAN.

For example, if the S-RAN supporting RACS determines that the T-RAN supports RACS but the format of URC information is different then the S-RAN provides the URC information in the format supported by the T-RAN. The T-RAN receives the URC information in the required format directly from the S-RAN and hence the delay in the handover procedure is reduced.

During the handover procedure, if the S-RAN supporting the RACS determines that the T-RAN supports RACS but the format of URC information and the URC-ID is different from the format supported by the S-RAN then the S-RAN provides the URC information in the format supported by the T-RAN, instead of the URC-ID in the source to target transparent container. The T-RAN receives the URC information in the required format directly from the S-RAN.

At the step 404, the S-RAN sends the URC-ID to the T-RAN upon determining availability of the URC information corresponding to URC-ID at the T-RAN. For example, when the S-RAN and the T-RAN both use the same format for storing the URC information, then the S-RAN sends the URC-ID to the T-RAN.

At the step 405, the T-RAN performs the handover procedure with the UE (101) using one of the URC-ID and the URC information.

In an embodiment, the T-RAN performs the handover procedure of the UE (101) by receiving the URC information from the S-RAN and completing the handover procedure using the URC information. The person skilled in the art appreciates the use of existing handover procedures for completing the UE (101) handover.

In an embodiment, the T-RAN performs the handover procedure of the UE (101) by receiving the URC information from the S-RAN (as part of source to target transparent container sent by the S-RAN). Further, receiving the URC-ID from the AMF (105) or the MME (106). Furthermore, completing the handover procedure using the URC information received from the S-RAN. For example, if the S-RAN stores the URC information in the 36.331 format, and the T-RAN supports 38.331 format, then the S-RAN provides the URC information, however, the T-RAN may obtain the URC-ID corresponding to the URC information stored in the 38.331 format from the AMF (105). The T-RAN completes the handover procedure of the UE (101) using the URC provided by the S-RAN, instead of using the stored URC information. Once the handover procedure is completed, the T-RAN requests for resolution of the URC-ID and updates the URC information in the UE (101) context. In another embodiment, the resolution of the URC-ID is done by the T-RAN after the UE (101) gets into INACTIVE state.

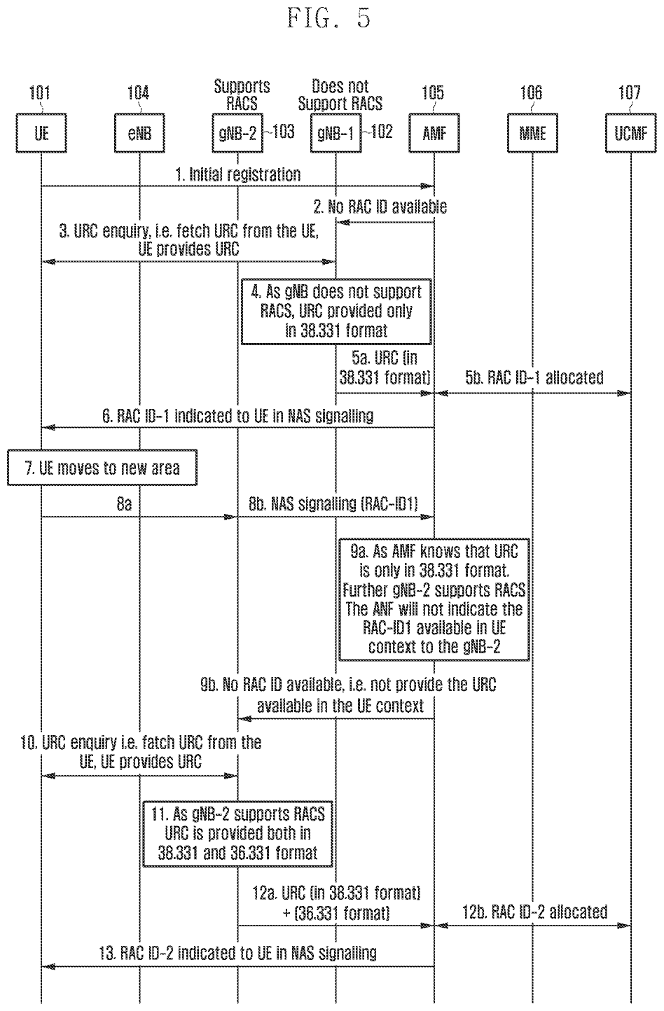

FIG. 5 is a signaling diagram illustrating a procedure of a procedure of UE (101) handover when the URC information or the URC-ID is not available in the required format, according to the embodiments as disclosed herein.

Referring to the FIG. 5, the UE (101) initiates the initial registration procedure in the 5GS, when the UE (101) does not have the URC-ID allocated by the 5GS as indicated by the signal 1 in FIG. 5, sent by the UE (101) to the AMF (105). The AMF (105) cannot provide UE (101) radio capabilities (URC) information to gNB-1 (102) servicing the UE (101) because the URC-ID is not allocated to the UE (101) and the AMF (105) do not possess the URC information corresponding to the UE (101) in a mapping stored by the AMF (105). The AMF (105) indicates the non-availability of the URC information and the URC-ID corresponding to the UE (101) to the gNB-1 (102) as indicated by the signal 2 in FIG. 5. Further, due to un-availability of the URC information at gNB-1 (102), the gNB-1 (102) fetches the URC information from the UE (101) as indicated by the signal 3 in FIG. 5. The UE (101) provides the URC information in TS 38.331 format, because the gNB-1 (102) does not support URC optimization technique i.e. RACS as indicated by the signal 4 in FIG. 5. Further, the gNB-1 (102) provides the URC information in the TS 38.331 format to the AMF (105) as indicated by the signal 5a in FIG. 5. The gNB-1 (102) will not be able to provide the URC information in both the 38.331 format and the 36.331 format to the AMF (105) because the PLMN is operating in a Mode-A. In Mode-A of operation, the UCMF (107) is not capable of translating or transcoding the URC information from the 38.331 format to the 36.331 format. Alternatively, if the gNB-1 (102) is not upgraded, the gNB-1 (102) is not be able to provide the URC information in both the 36.331 format and the 38.331 format to AMF (105) in the Core Network (CN). The AMF (105) requests URC-ID assignment corresponding to the URC information to the UCMF (107). The UCMF (107) allocates a value of the URC-ID (for example, say URC-ID1) corresponding to the URC information of the UE (101). Further, the URC-ID1 is indicated to the AMF (105) as indicated by the signal 5b in FIG. 5. The AMF (105) provides the URC-ID1 to the UE (101) in a NAS signaling message as indicated by the signal 6 in FIG. 5. Further, the AMF (105) stores the mapping of the URC-ID with the URC information in the 38.331 format only.

In an embodiment, the UE (101) may move from a geographical area serviced by the gNB-1 (102) to a geographical area serviced by gNB-2 (103) in the 5GS as indicated by the signal 7 in FIG. 5. For example, consider the gNB-2 (103) to support RACS. The UE (101) provides the URC-ID1 in the NAS signaling to the AMF (105)-1 as indicated by signal 8a. and 8b in FIG. 5. The AMF (105) and/or S-RAN determines from the mapping that the URC-ID corresponds to the URC information in 38.331 format only and the URC information in the 36.331 format is un-available or vice versa as indicated by signal 9a in FIG. 5. Further, the AMF (105) and/or S-RAN determines that the T-RAN supports the RACS as indicated by signal 9.b in FIG. 5. Therefore, the AMF (105) and/or S-RAN does not provide the URC-ID1 (or the URC information) available in UE (101) context to the gNB-2 (103). Further, the AMF (105) and/or S-RAN does not provide the URC-ID received from the UE (101) to the gNB-2 (103) as indicated by signal 9.b in FIG. 5.

In an embodiment, due to the un-availability of the URC information, the gNB-2 (103) obtains the URC information from the UE (101) as indicated by signal 10 in FIG. 5. The URC is obtained by the gNB-2 (103) in both the 38.331 format and the 36.331 format because the gNB-2 (103) supports URC optimization technique i.e. RACS as indicated by signal 11 in FIG. 5. Further, the gNB-2 (103) provides the URC information in 38.331 format and 36.331 format to the CN including the AMF (105), as indicated by signal 12.a in FIG. 5. The UCMF (107) provides a new value of the URC-ID to the AMF (105) as indicated by signal 12.b in FIG. 5. The AMF (105) provides the URC-ID to the UE (101) via the NAS signaling as indicated by signal 13 in FIG. 5.

In an embodiment, if the S-RAN determines that the URC-ID received from the CN or from the UE (101)supports only one format which is not current system format (i.e. if the S-RAN is eNB (104), the S-RAN will not understand the 38.331 format, similarly if the S-RAN is the gNB, the S-RAN will not understand the 36.331 format) then CN node (i.e., AMF (105)/MME (106)) does not provide the URC-ID of the UE (101) to the S-RAN node.

For example, let the URC information of the UE-A be 5G={aaa}, 4G={bbb}, 3G={ccc}, 2G={ddd}. The UE-A performs the following operations:

1. UE-A registers in 5G with gNB

2. UCMF (107) allocates URC-ID1 to the UE-A. The UCMF (107) stores the mapping of the URC-ID1 with the corresponding URC information i.e. (5G={aaa}, 4G={bbb}) in 38.xxx format.

3. The UE-A moves from 5G to 4G.

4. The UE-A provides the URC-ID1 to the CN.

5. The eNB (104) receives the URC information (5G={aaa}, 4G={bbb}) from the CN. The eNB (104) obtains from the UE (101) the URC information related to 3G and 2G i.e., 3G={ccc}, 2G={ddd} in 36.331 format.

6. The eNB (104) provides the URC information related to 3G and 2G in the 36.331 format to the CN and the UCMF (107) in the CN concatenates the URC information related to 3G and 2G in the 36.331 format with the existing URC information in 38.331 format associated with the URC-ID-1.

7. The UCMF (107) database has the mapping for the URC-ID1 with the URC information (5G={aaa}, 4G={bbb}) in 38.xxx format; and 5G={aaa}, 4G={bbb}, 3G={ccc}, 2G={ddd} in 36.xxx format.

8. Here 38.xxx means 38 series of specification i.e. 38.331 and 36.xxx means 36 series of specification i.e. 36.331.

In an embodiment, the AMF (105) shall remember that the URC-ID of the UE (101) corresponds to only 38.331 format when the URC information in received in the 38.331 format alone from the gNB-1 (102) that does not support the RACS as indicated in step 5a of the FIG. 5. During N2 or NgeNB (104) signaling, if the AMF (105) determines that the URC-ID in UE (101) context belongs to only 38.331 format and the currently servicing RAN (i.e. eNB (104)) supports RACS then AMF (105) shall not indicate the URC-ID to the eNB (104). So that fresh URC information is obtained from the UE (101). Further, both the formats of 36.331 and 38.331 formats can be generated by the eNB (104). The UCMF (107) provides a new value of the URC-ID to the UE (101) which is having both 36.331 and 38.331 formats.

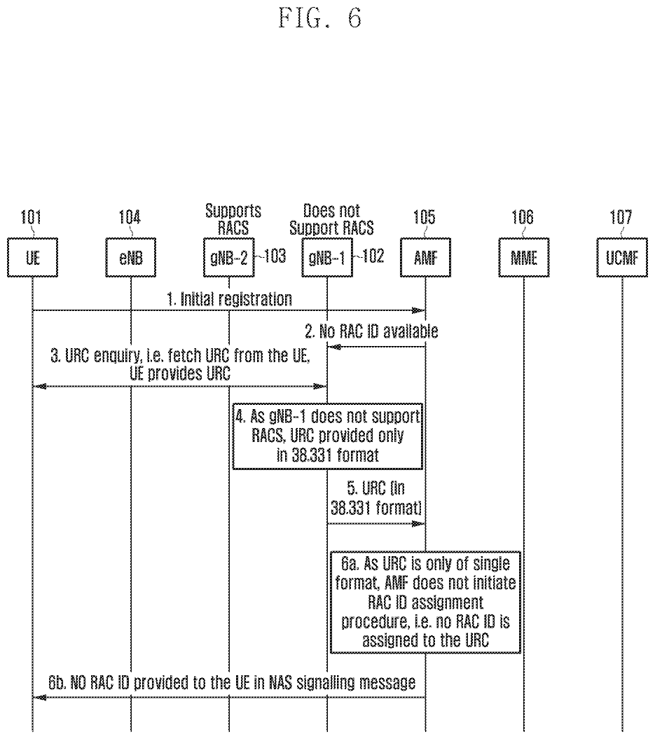

FIG. 6 is another a signaling diagram illustrating a procedure of UE (101) registration with a RAN that does not support the RACS, according to the embodiments as disclosed herein.

Referring to the FIG. 6, the UE (101) initiates the initial registration procedure in the 5GS, when the UE (101) does not have the URC-ID allocated by the 5GS as indicated by the signal 1 in FIG. 6, sent by the UE (101) to the AMF (105). The AMF (105) cannot provide UE (101) radio capabilities (URC) information to gNB-1 (102) servicing the UE (101) because the URC-ID is not allocated to the UE (101) and the AMF (105) do not possess the URC information corresponding to the UE (101) in a mapping stored by the AMF (105). The AMF (105) indicates the non-availability of the URC information and the URC-ID corresponding to the UE (101) to the gNB-1 (102) as indicated by the signal 2 in FIG. 6. Further, due to un-availability of the URC information at gNB-1 (102), the gNB-1 (102) fetches the URC information from the UE (101) as indicated by the signal 3 in FIG. 6. The UE (101) provides the URC information in TS 38.331 format, because the gNB-1 (102) does not support URC optimization technique i.e. RACS as indicated by the signal 4 in FIG. 6. Further, the gNB-1 (102) provides the URC information in the TS 38.331 format to the AMF (105) as indicated by the signal 5 in FIG. 6. The gNB-1 (102) will not be able to provide the URC information in both the 38.331 format and the 36.331 format to the AMF (105) because the PLMN is operating in a Mode-A. In Mode-A of operation, the UCMF (107) is not capable of translating or transcoding the URC information from the 38.331 format to the 36.331 format. Alternatively, if the gNB-1 (102) is not upgraded, the gNB-1 (102) is not be able to provide the URC information in both the 36.331 format and the 38.331 format to AMF (105) in the Core Network (CN). The AMF (105) requests URC-ID assignment corresponding to the URC information to the UCMF (107).

In an embodiment, after the URC information is received by the CN (AMF (105)/MME (106)) and if the S-RAN does not support the RACS then the CN node does not assign URC-ID corresponding to the URC information of the UE (101) as indicated by the signal 6a in FIG. 6. The AMF (105)/MME (106) does not invoke URC-ID assignment procedure with UCMF (107) as indicated by the signal 6a in FIG. 6. Further, the AMF (105) indicates a null value for the URC-ID to the UE (101) in the NAS signaling procedure as indicated by the signal 6b in FIG. 6.

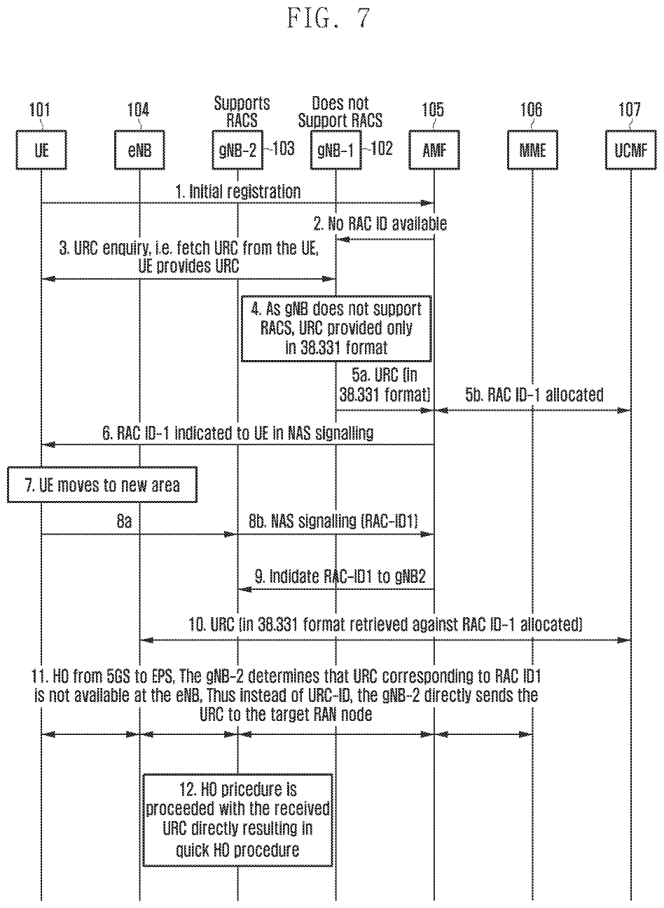

FIG. 7 shows a signaling diagram illustrating a procedure of UE (101) handover when the T-RAN supports RACS, according to the embodiments as disclosed herein.

Referring to the FIG. 7, the UE (101) initiates the initial registration procedure in the 5GS, when the UE (101) does not have the URC-ID allocated by the 5GS as indicated by the signal 1 in FIG. 7, sent by the UE (101) to the AMF (105). The AMF (105) cannot provide UE (101) radio capabilities (URC) information to gNB-1 (102) servicing the UE (101) because the URC-ID is not allocated to the UE (101) and the AMF (105) do not possess the URC information corresponding to the UE (101) in a mapping stored by the AMF (105). The AMF (105) indicates the non-availability of the URC information and the URC-ID corresponding to the UE (101) to the gNB-1 (102) as indicated by the signal 2 in FIG. 7. Further, due to un-availability of the URC information at gNB-1 (102), the gNB-1 (102) fetches the URC information from the UE (101) as indicated by the signal 3 in FIG. 7. The UE (101) provides the URC information in TS 38.331 format, because the gNB-1 (102) does not support URC optimization technique i.e. RACS as indicated by the signal 4 in FIG. 7. Further, the gNB-1 (102) provides the URC information in the TS 38.331 format to the AMF (105) as indicated by the signal 5a in FIG. 7. The gNB-1 (102) will not be able to provide the URC information in both the 38.331 format and the 36.331 format to the AMF (105) because the PLMN is operating in a Mode-A. In Mode-A of operation, the UCMF (107) is not capable of translating or transcoding the URC information from the 38.331 format to the 36.331 format. Alternatively, if the gNB-1 (102) is not upgraded, the gNB-1 (102) is not be able to provide the URC information in both the 36.331 format and the 38.331 format to AMF (105) in the Core Network (CN). The AMF (105) requests URC-ID assignment corresponding to the URC information to the UCMF (107). The UCMF (107) allocates a value of the URC-ID (for example, say URC-ID1) corresponding to the URC information of the UE (101). Further, the URC-ID1 is indicated to the AMF (105) as indicated by the signal 5b in FIG. 7. The AMF (105) provides the URC-ID1 to the UE (101) in a NAS signaling message as indicated by the signal 6 in FIG. 7. Further, the AMF (105) stores the mapping of the URC-ID with the URC information in the 38.331 format only.

In an embodiment, the UE (101) may move from a geographical area serviced by the gNB-1 (102) to a geographical area serviced by gNB-2 (103) in the 5GS as indicated by the signal 7 in FIG. 7. For example, consider the gNB-2 (103) to support RACS. The UE (101) provides the URC-ID1 in the NAS signaling to the AMF (105)-1 as indicated by signal 8a. and 8b in FIG. 7. The AMF (105) and/or S-RAN determines from the mapping that the URC-ID corresponds to the URC information in 38.331 format only. Because the gNB-2 (103) supports RACS, the AMF (105) and/or S-RAN provides the URC-ID1 to the T-RAN (i.e. gNB-2 (103)) as indicated by signal 9 in FIG. 7. The gNB-2 (103) requests the AMF (105) and/or the UCMF (107) for the resolution of URC-ID1 as indicated by signal 10 in FIG. 7. The gNB-2 (103) receives the URC information in the 38.331 format from the CN including the AMF (105) and UCMF (107) as indicated by signal 10 in FIG. 7.

In an embodiment, for example if the handover is triggered from 5GS to EPS (handover procedure can be triggered between any source and target RAN for example EPS (eNB) to EPS, EPS to 5GS (Ng-eNB or gNB) or 5GS to 5GS) as indicated by signal 11 in FIG. 7. The S-RAN determines if the T-RAN (i.e. eNB (104)) has the URC information corresponding to the URC-ID1. If S-RAN determines that the eNB (104) may not have the URC information of the UE (101) for example, because the eNB (104) uses the format say 36.331 that is different from the format used by the S-RAN say 38.331 or say the URC information is fetched from the UE (101) by the S-RAN and the corresponding URC-ID is a new value provided by the CN, then the URC information corresponding to the URC-ID may not be available the T-RAN. Further, when the URC information is received from the CN and a mapping was created by the CN or when the S-RAN based on a learning module or artificial intelligence module predicts that the T-RAN may not have the URC information corresponding to the URC-ID and the like, the S-RAN sends the URC information to the eNB (104) instead of sending the URC-ID1 as indicated by signal 11 in FIG. 7. Further, the S-RAN predicts the availability of URC information and/or the URC-ID at T-RAN. If S-RAN garners the knowledge that there is less probability of having URC information at the T-RAN then the S-RAN sends the URC information to the eNB (104) instead of sending the URC-ID1 as indicated by signal 11 in FIG. 7. The handover procedure is executed with reduced delay and results in higher resource utilization at a Xn interface between S-RAN and T-RAN as the size of the the URC information is more when compared to the size of the URC-ID. The eNB (104) or T-RAN receives the required URC information of the UE (101) and performs the handover procedure of the UE (101) as indicated by signal 12 in FIG. 7. Therefore, the handover of the UE (101) is performed with a reduced delay compared to the prior art detailed in the FIG. 1. The delay in the handover is reduced because the resolution of the URC-ID1 to URC information is eliminated as the S-RAN sends the URC information to the T-RAN and the T-RAN directly completes the handover procedure.

In yet another embodiment, the AMF (105) provides the URC-ID to the S-RAN during the N2 signaling along with the information that indicates the formats of the URC information. If the URC-ID belongs to only one format then the S-RAN generates the URC information in other formats and provides the generated URC information to the CN. The UCMF (107) in the CN provides a new value of the URC-ID or the existing URC-ID is updated with the coding format associated with the generated URC information. To update the existing URC-ID, the CN node (AMF (105) or MME (106)) provides the URC-ID corresponding to the URC information of the UE (101).

In yet another embodiment, the AMF (105) requests the gNB to generate the URC information in both 36.331 and 38.331 formats without the need to fetch the URC information from the UE (101), i.e., the AMF (105) indicates to gNB supporting RACS that the URC information is available in only one format (for example, say 38.331 format) and provides the URC information of the UE (101) in 38.331 format. Further, the gNB generates the URC information in both 36.331 and 38.331 formats and provides the URC information to the CN. The CN updates the URC information in the database with the same URC-ID or allocates new value of the URC-ID and indicates the new value of the URC-ID to the UE (101).

In the proposed method, the RAN generating both the coding formats on request from AMF (105) or by knowing the current URC-ID is available for only one coding format RAN generating by itself(without a request from the AMF (105)) select can be based on the criteria that UE (101) also supports respective radio access technologies.

When the UCMF (107) receives the URC information in both the 36.331 format and 38.331 format. The UCMF (107) allocates the URC-ID after taking into consideration both the URC formats. i.e. for example

URC-ID-1=“xxx” (in 36.331 format)

URC-ID-2=“xxx” (in 36.331 format)+“yyy” (in 38.331 format)

i.e. even though 36.331 format URC is same, the UCMF (107) allocates a different URC-ID by taking both (in general all available formats) the formats into account. The URC-ID is the combination of all the available URC information in different coding formats.

The AMF (105) shall remember that the URC-ID belongs to only 38.331 format when the URC is received from non RACS supporting gNB (or nextgenNB (104)) i.e. when single coding format URC is received from the RAN node and URC-ID gets assigned to that particular URC-ID. AMF (105) shall transferred this information to the target AMF (105) too whether the URC-ID have URC for 36.331 format or 38.331 format or both the formats i.e. in general AMF (105) shall indicate which all formats the URC-ID represents to the target AMF (105) or MME (106) each time the UE (101) context is transferred to the target.

All the description provided in this embodiment is from the AMF (105) perspective but same issue is applicable with respect to the MME (106). i.e. all places where the CN and RAN are exchanged with respective CN and RAN nodes of other system. Then same issue is observed and same solution can be applied.

In yet another embodiment, during the handover procedure the CN provides the URC-ID which does not belong to all the coding formats but the format supported by the T-RAN so that T-RAN obtains the required URC information from the UE (101) and the delay in the HO procedure is reduced.

In yet another embodiment, if it's not a HO procedure and the CN receives the URC-ID which does not belong to all the coding formats but supports coding format of the T-RAN, then the CN does not provide the URC-ID to the T-RAN so that the T-RAN generates the URC information in all the coding formats and provides the URC information to the CN. Alternatively, the CN provides the URC-ID or the URC information to the T-RAN and requests T-RAN to generate URC information in all the coding formats.

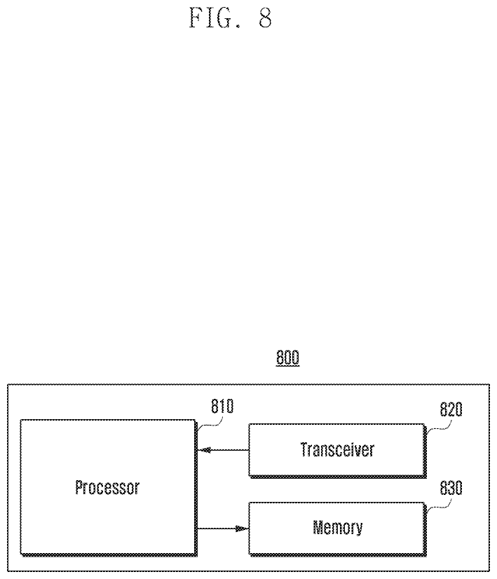

FIG. 8 illustrates a UE according to embodiments as disclosed herein.

Referring to the FIG. 8, the UE 800 may include a processor 810, a transceiver 820 and a memory 830. However, all of the illustrated components are not essential. The UE 800 may be implemented by more or less components than those illustrated in FIG. 8. In addition, the processor 810 and the transceiver 820 and the memory 830 may be implemented as a single chip according to another embodiment.

The UE 800 may correspond to UE described above. For example, the UE 800 may correspond to the UE in FIG. 3A.

The aforementioned components will now be described in detail.

The processor 810 may include one or more processors or other processing devices that control the proposed function, process, and/or method. Operation of the UE 800 may be implemented by the processor 810. The processor 810 may control a signal flow between each block to perform the proposed function, process, and/or method according to the embodiments of the present disclosure.

The transceiver 820 may include a RF transmitter for up-converting and amplifying a transmitted signal, and a RF receiver for down-converting a frequency of a received signal. However, according to another embodiment, the transceiver 820 may be implemented by more or less components than those illustrated in components.

The transceiver 820 may be connected to the processor 810 and transmit and/or receive a signal. The signal may include control information and data. In addition, the transceiver 820 may receive the signal through a wireless channel and output the signal to the processor 810. The transceiver 820 may transmit a signal output from the processor 810 through the wireless channel.

The memory 830 may store the control information or the data included in a signal obtained by the UE 800. The memory 830 may be connected to the processor 810 and store at least one instruction or a protocol or a parameter for the proposed function, process, and/or method. The memory 830 may include read-only memory (ROM) and/or random access memory (RAM) and/or hard disk and/or CD-ROM and/or DVD and/or other storage devices.

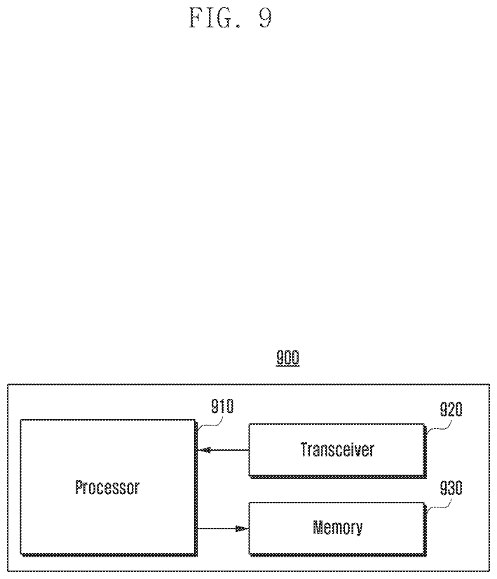

FIG. 9 illustrates a RAN according to embodiments as disclosed herein.

Referring to the FIG. 9, the RAN 900 may include a processor 910, a transceiver 920 and a memory 930. However, all of the illustrated components are not essential. The RAN 900 may be implemented by more or less components than those illustrated in FIG. 9. In addition, the processor 910 and the transceiver 920 and the memory 930 may be implemented as a single chip according to another embodiment.

The RAN 900 may correspond to the RAN described in the present disclosure. For example, the RAN 900 may correspond to the RAN in FIG. 3B.

The aforementioned components will now be described in detail.

The processor 910 may include one or more processors or other processing devices that control the proposed function, process, and/or method. Operation of the RAN 900 may be implemented by the processor 910. The processor 910 may control a signal flow between each block to perform the proposed function, process, and/or method according to the embodiments of the present disclosure.

The transceiver 920 may include a RF transmitter for up-converting and amplifying a transmitted signal, and a RF receiver for down-converting a frequency of a received signal. However, according to another embodiment, the transceiver 920 may be implemented by more or less components than those illustrated in components.

The transceiver 920 may be connected to the processor 910 and transmit and/or receive a signal. The signal may include control information and data. In addition, the transceiver 920 may receive the signal through a wireless channel and output the signal to the processor 910. The transceiver 920 may transmit a signal output from the processor 910 through the wireless channel.

The memory 930 may store the control information or the data included in a signal obtained by the RAN 900. The memory 930 may be connected to the processor 910 and store at least one instruction or a protocol or a parameter for the proposed function, process, and/or method. The memory 930 may include read-only memory (ROM) and/or random access memory (RAM) and/or hard disk and/or CD-ROM and/or DVD and/or other storage devices.

The embodiments disclosed herein can be implemented using at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1-14. (canceled)

15. A method performed by a source-radio access network (S-RAN) in a communication system, the method comprising:
determining that the S-RAN and a target-radio access network(T-RAN) support a user equipment radio capability (URC) signaling optimization (RACS);
identifying whether URC information corresponding a URC identification (ID) of a user equipment is available at the T-RAN; and
in case that the URC information corresponding to the URC ID is unavailable at the T-RAN, transmitting to the T-RAN, the URC information.

16. The method of claim 15, further comprising:
identifying whether the URC information corresponding to the URC ID is available at the T-RAN further comprising:
identifying whether the URC information in the S-RAN is obtained from an access and mobility management function (AMF), and
in case that the URC information in the S-RAN is obtained from the AMF, determining that the URC information corresponding to the URC ID is unavailable at the T-RAN.

17. The method of claim 15, further comprising:
identifying whether the information associated with URC corresponding to the URC ID is available at the T-RAN further comprising:
identifying a format of the URC information corresponding to the URC-ID stored in the S-RAN is same as the format of the URC information supported by the T-RAN, and
in case that the format of the URC information corresponding to the URC-ID stored in the S-RAN is same as the format of the URC information supported by the T-RAN, determining that the URC information corresponding to the URC ID is available at the T-RAN.

18. The method of claim 15, further comprising:
transmitting the user equipment radio capability identification URC-ID to the T-RAN, based on that the S-RAN and the T-RAN support the RACS.

19. The method of claim 15, wherein the URC information is used to perform a handover with the UE.

20. A method performed by a target-radio access network (T-RAN) in a communication system, the method comprising:
in case that user equipment radio capability (URC) information corresponding to a URC identification (ID) is unavailable at the T-RAN, receiving the URC information from a source-radio access network(S-RAN); and
performing a handover procedure with a UE based on the URC information.

21. The method of claim 20, further comprising:
receiving the user equipment radio capability identification (URC ID) from the S-RAN.

22. The method of claim 20, further comprising:
in case that the T-RAN received the URC information and the URC-ID, performing the handover based on the URC information.

23. The method of claim 20, wherein the URC information is used to complete the handover with the UE.

24. The method of claim 20, wherein the T-RAN and the S-RAN support URC signaling optimization (RACS).

25. A source-radio access network (S-RAN) in a communication system, the S-RAN comprises:
a transceiver; and
a processor couples with the transceiver,
the processor configured to:
determine that the S-RAN and a target-radio access network(T-RAN) support a user equipment radio capability (URC) signaling optimization (RACS),
identify whether URC information corresponding a URC identification (ID) of a user equipment is available at the T-RAN, and
transmit to the T-RAN, the URC information.

26. The S-RAN of claim 25, wherein the processor is further configured to:
identify whether the URC information in the S-RAN is obtained from an access and mobility management function (AMF), and
in case that the URC information in the S-RAN is obtained from the AMF, determine that the URC information corresponding to the URC ID is unavailable at the T-RAN.

27. The S-RAN of claim 25, wherein the processor is further configured to:
identify a format of the URC information corresponding to the URC-ID stored in the S-RAN is same as the format of the URC information supported by the T-RAN, and
in case that the format of the URC information corresponding to the URC-ID stored in the S-RAN is same as the format of the URC information supported by the T-RAN, determine that the URC information corresponding to the URC ID is available at the T-RAN.

28. The S-RAN of claim 25, wherein the processor is further configured to:
transmit the user equipment radio capability identification URC-ID to the T-RAN, based on that the S-RAN and the T-RAN support the RACS.

29. The S-RAN of claim 25, wherein the URC information is used to perform a handover with the UE.

30. A target-radio access network (T-RAN) in a communication system, the S-RAN comprises:
a transceiver; and
a processor couples with the transceiver,
the processor configured to:
receive the URC information from a source-radio access network(S-RAN), and
perform a handover procedure with a UE based on the URC information.

31. The S-RAN of claim 30, wherein the processor is further configured to:
receive the user equipment radio capability identification (URC ID) from the S-RAN.

32. The S-RAN of claim 30, wherein the processor is further configured to:
perform the handover based on the URC information, in case that the T-RAN received the URC information and the URC-ID.

33. The S-RAN of claim 30, wherein the URC information is used to complete the handover with the UE.

34. The S-RAN of claim 30, wherein the T-RAN and the S-RAN support URC signaling optimization (RACS).
